(19) United States
(12) Patent Application Publication
(10) Pub. No.: US 2021/0060737 A1
(43) Pub. Date: Mar. 4, 2021

(54) TWO JAW ADJUSTABLE AND EXTENDABLE WRENCH

(71) Applicant: Thomas Carnesi, Torrance, CA (US)

(72) Inventor: Thomas Carnesi, Torrance, CA (US)

(21) Appl. No.: 16/559,586

(22) Filed: Sep. 3, 2019

(51) Int. Cl. B25B 13/14; B25B 23/00; B25G 1/04

(52) U.S. Cl. CPC B25B 13/14; B25G 1/043; B25B 23/0028

(57) ABSTRACT

A two-jaw adjustable wrench wherein both jaws are movable simultaneously toward or apart from each other.

### BACKGROUND OF INVENTION

### Field of the invention

This invention relates to wrenches and, more specifically, to a ratcheting adjustable wrench that has two jaws, both jaws being movable simultaneously.

### Description of the Prior Art

Ratcheting adjustable wrenches are well known in the prior art. For example, U.S. Pat. No. 7,275,464 to Chervenak et al discloses a wrench having a handle that is pivotably connected to a body portion, the body portion supporting a fixed jaw. A movable jaw is slidably supported on the body portion such that the ⅜ movable jaw can move relative to the fixed jaw to vary the spacing between the jaws. When the handle is rotated in a first direction the spacing between the jaws increases to allow the jaws to slip over a workpiece and provide a ratchet function. When the handle is rotated in a second direction opposite to the first direction the movable jaw is moved towards the fixed jaw to close on and grip the workpiece.

Although the wrench described in the '464 patent performs certain desirable functions, a major drawback is that the distance between the fixed and movable jaws is limited, thus reducing the range of fasteners heads that can be operated upon by the wrench.

What is desired is to provide a wrench having two jaws that are configured to move simultaneously wherein the space therebetween is adjustable to a degree wherein the wrench can operate on fasteners having a multitude of head diameters.

### SUMMARY OF THE PRESENT INVENTION

The present invention provides a two jaw adjustable wrench that has a handle that can be extended to a first and second position. The two jaws are opposing and are adjusted by a left hand and a right hand threaded internal horizontal screw. The distance range between the opposing jaw members are 14 to 1 inch the latter being the maximum opening. The adjustable wrench can be used on both hexagonal and square configured nuts and bolts of various sizes.

Two options are available to the user for gripping the fasteners: smaller square or hex shaped size fasteners which can be gripped from either the v-end configured jaws, a central opening that is formed within the two opposing jaws and for larger size fasteners on the flat vertical surfaces of the both opposing jaws, depending on the torque needs. As the user rotates a central knurled cylindrical knob in an upward or clockwise rotation, the opposing jaws are caused to move apart to a wider and larger opening for larger hexagon or square fasteners.

Counterclockwise or downward rotation of the knurled knob reactivates the jaws to move back inwardly or closer together for smaller hex or square size fasteners (the two opposing jaw form a ⅜ V-diamond opening at full closed position for the smallest hex fastener sizes). As the jaws are adjusted outward, the 120 degrees v-notch becomes larger by separation of the jaw travel distance. The internal right hand and left hand thread screw is housed within the main wrench and is secured by a central external knurled cylindrical thumb piece wheel. The two opposing jaw members have a cylindrical configuration at their horizontal bottom end which ride within the horizontal bore of the upper portion the cylindrical housing of the wrench; each opposing jaw has a left and right hand female thread to accept the male right hand and left hand male threaded horizontal screw. The two opposing jaws are each secured by a roll pin which they both simultaneously ride within those two horizontal slots to secure both opposing jaws to the upper cylindrical frame, and to travel a distance as the jaws are adjusted apart. The central portion of the upper cylindrical frame has a square slot to house the knurled adjusting wheel and is secured by a roll pin press fitted within the matched aligned holes in the central part of the left hand and right hand threaded internal jaws adjusting screw. The extreme upper portion of the main handle frame has a horizontal slot across its entire length to house the opposing jaws lower portion that ride within the horizontal slotted feature and secured by two opposing press fitted roll pins. The lower handle extension of the wrench frame is narrowed and elongated to accept a hollowed slidable handle shell that adjust to a first and a second extension for various torque needs by the user. The slide handle has a thumb indentation on both sides for ease of extension retraction. Two first and second extension detent spring induced ball bearings snap into the vertical hole of the handles outer shell to secure it during wrench usage.

The two-jaw adjustable wrench has a swivel connecting yoke which houses two vertical opposing jaws, each having a triangular notch for grasping hex shape fasteners more efficiently, one opposing jaw having a right-hand interior thread and the opposing jaw having a left-hand interior thread. The opposing jaws are activated by rotating an adjustable knurl wheel that is connected at the central square opening of the connecting yoke. Both the horizontal right and left hand threaded jaws are both secured by two vertical roll, or dowel pins; the male right hand and left hand threads meet with the opposing jaws interior female threads and of the same right and left hand thread screw pitch. The connecting yoke is attached onto the female slot of the main extending wrench arm and is secured onto the yolks neck with a horizontal roll pin. Clockwise rotation of the knurled wheel activates the opposing jaws to move to or outward distance for larger fasteners sizes and counterclockwise wheel activates the jaws to adjust inward for smaller hexagonal shaped fastener sizes.

### DESCRIPTION OF THE DRAWINGS

For better understanding of the present invention as well as other objects and further features thereof, reference is made to the following description which is to be read in conjunction with the in accompanying drawing wherein:

FIG. 1 is an exploded view of one embodiment of the extendable wrench of the present invention;

FIG. 2 is a top view of the wrench shown in FIG. 1, with the jaws in the closed position;

FIG. 2a is cross-sectional view along line 2A-2A of FIG. 2;

FIG. 3 is a cross-sectional view along line 3-3 of FIG. 2;

FIG. 4 is a right side edge view of the wrench shown in FIG. 1;

FIG. 5 is a an isometric view of the wrench shown in FIG. 1;

FIG. 6 shows the wrench of the present invention with the jaws closed engaging a ⅜ inch hex fastener with the handle shown in the non-extended position:

FIG. 7 shows the wrench with the jaws positioned to engage a ¾ inch hex fastener with the handle extended to a first position;

FIG. 8 shows the wrench with jaws extended to grasp a 1 11/32 inch fastener with the handle extended to a second position;

FIG. 9 is a view showing the threaded element at a first position that has the jaw members separated at an essentially closed position;

FIG. 10 is a view showing the threaded element rotated to a second position that has the jaw members separated by a second distance;

FIG. 11 is a view showing the threaded element at a third position that has the jaw members separated by a third distance;

FIG. 12 is a perspective view of a second embodiment of the present invention with the jaws at an angle to the horizontal;

FIG. 13 shows the jaws of FIG. 12 in the horizontal position; and

FIG. 14 is an exploded view-of the embodiment showing in FIG. 12.

### DESCRIPTION OF THE INVENTION

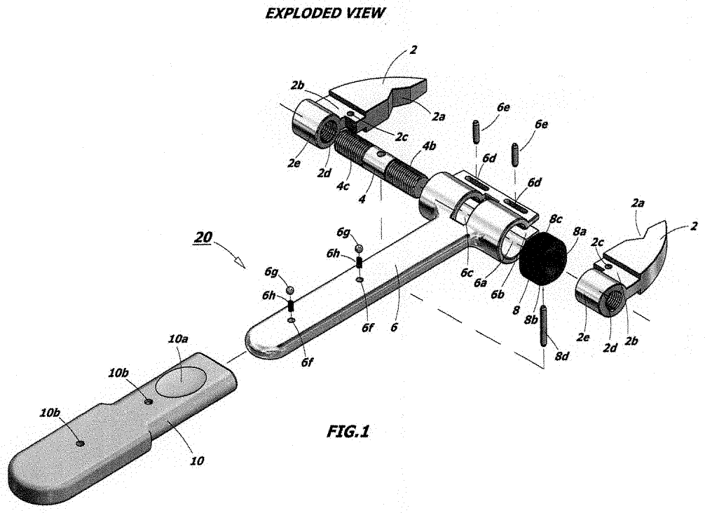

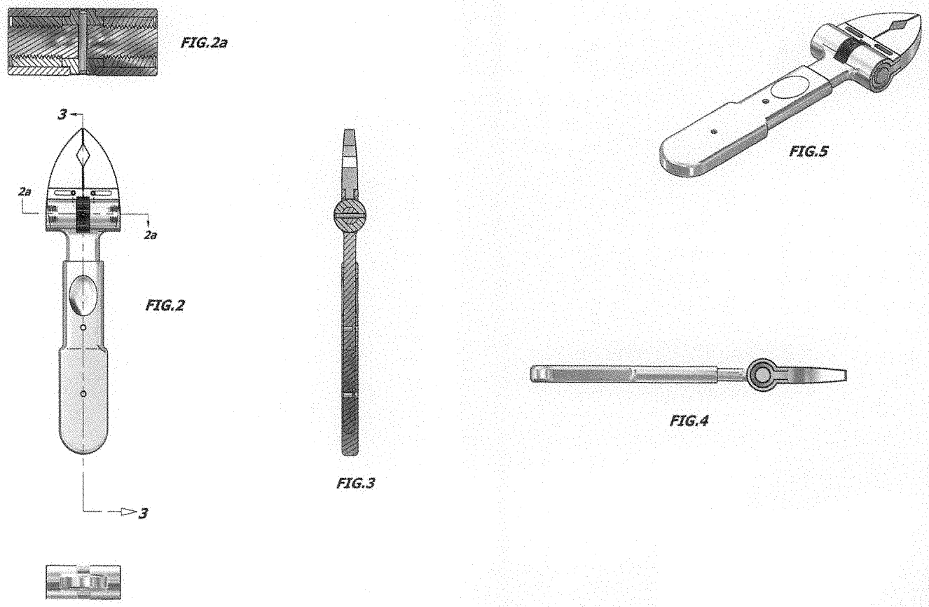

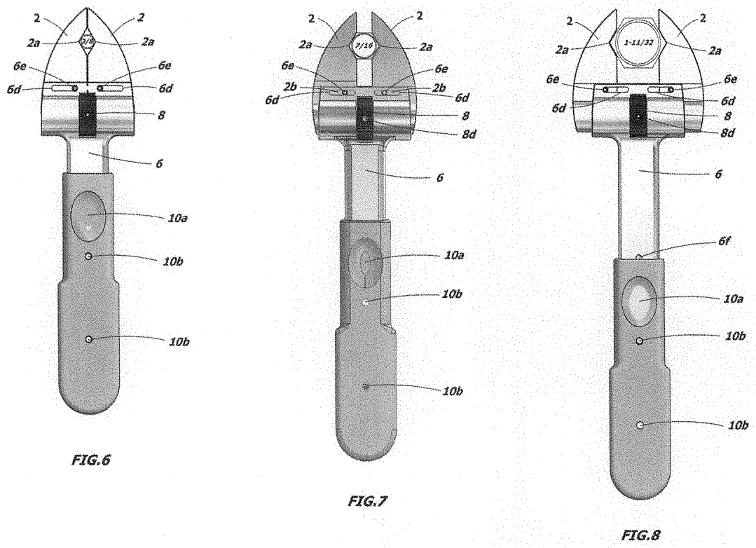

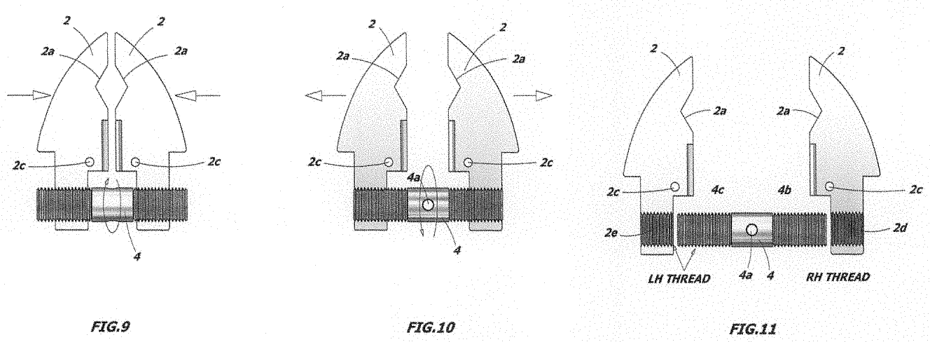

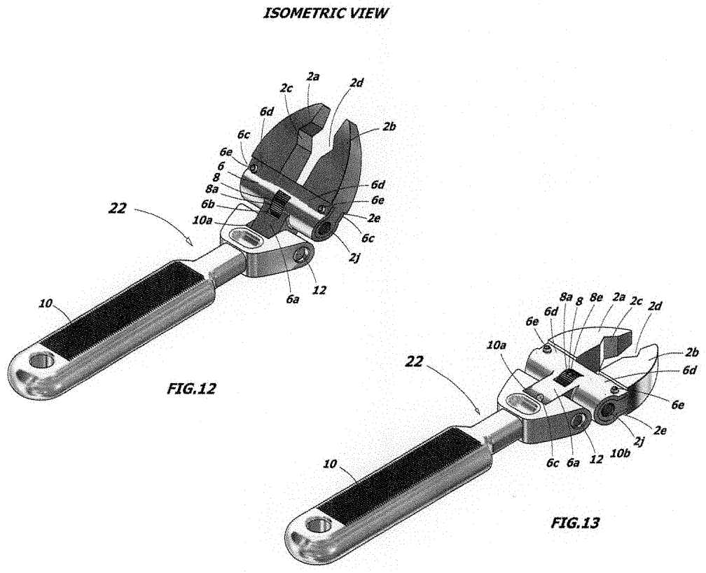

Referring to FIG. 1, jaws 2 of the wrench of the present invention is illustrated. V-notches 2a, angled at 120 degrees, are formed on the interior of both opposing jaws 2. The jaw necks 2b slides within the interior slotted horizontal channel 6b of T-frame, or yoke, 6. Vertical holes 2c retain two horizontal strap pins 6c that control the expansion and retraction of jaws 2 within right and left hand slots 6, the slots limiting movement of the jaws 2. Central knurled wheel 8a is rotateable to adjust jaws 2 to ride inward or outward when wheel 8 is rotated in the clockwise or counterclockwise direction. The jaws 2 ride horizontally within slot 6d of the upper horizontal T-frame 6. Exterior member 2e rides within horizontal bore 6c of T-frame 6. The right hand thread 2d and left hand thread 2e of jaws 2 are connected to horizontal right and left hand thread adjusting screw 4. The right hand external thread for 4b mates with thread 2d, thread 4c mateing with opposing jaw 2c via thread 2d.

The left hand and right hand horizontal thread bar 4 is rotated by central knurled wheel 8b. An interior bore of wheel 8b mates with the horizontal right hand and left hand thread bar 4. Central knurled wheel 8b is housed within the through slot 6c of T-frame member 6. An upward rotation of wheel 4 causes opposing jaws 2 to move inwardly, downward rotation of wheel 4 causing opposing jaws 2 to move inward. Downward rotation of wheel 4 causes opposing jaws 2 to move outwardly whereby the space between jaws 2 increases. Roll pins 6e secure and retain opposing jaws 2 with slots 6d formed in member 6b. Decent ball bearing 6g and compression spring 6h stops and retains the sliding shell handle 10 at a first extension position (represented by opening 10b) or a second extension position (represented by opening 10c). A thumb indentation 10a is provided to allow a user to grasp the shell handle 10 to pull to a downward extension for leverage or push upward to retract handle 10 to the closed position.

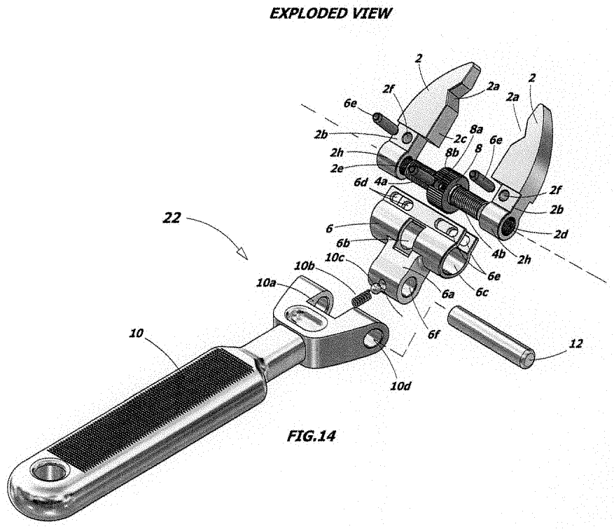

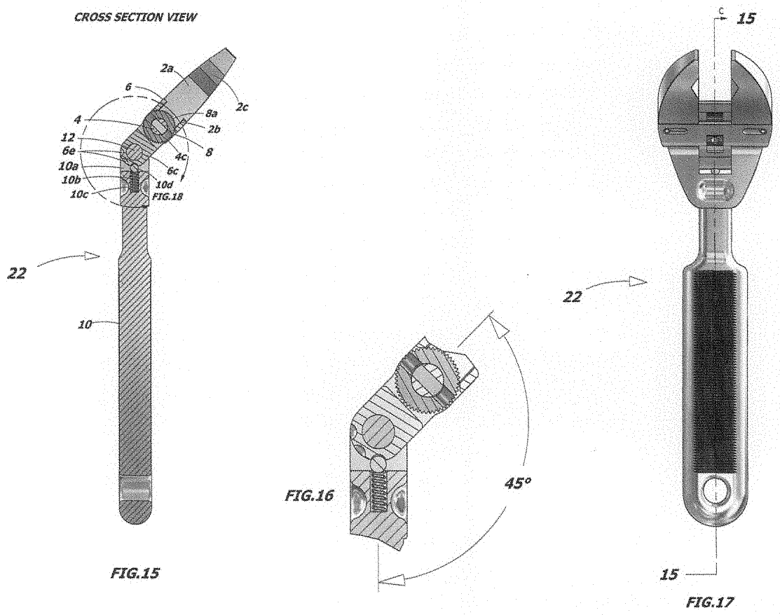

A second embodiment of the present invention is illustrated in FIGS. 12-14. A connecting yolk 6 which houses two vertical opposing jaws 2, each jaw 2a and 2b having a triangular notch 2c for grasping hex shape fasteners more efficiently, one opposing jaw having a right hand interior thread 2d and the opposing jaw having a left hand interior thread 2e; the opposing jaws 2 are activated by rotating adjusting knurl wheel 8 which is connected at the central square opening 6b of connecting yolk 6, a central dowel pin securing vertical right hand and left hand threaded interior shaft 4 having right and left hand threaded jaws 2 secured by two vertical dowel pins 6e. The male right hand and left hand threads 4a and 4b respectively, mate with the opposing jaws 2a and 2b interior female threads 2d and 2c of the same right and left hand thread screw pitch. The connecting yolk 6 is attached onto the female slot 10a of the main extending wrench arm 10 and is secured onto the yolk neck 6b with a horizontal dowel pin 12. Clockwise rotation of the knurled rotor wheel 8 activates the opposing jaws 2a and 2b to move outwardly for larger fastener sizes and counterclockwise rotation activates jaws 2a and 2b to adjust inward for smaller hex shaped fastener sizes. Modifying the wench shown in FIG. 1 to include yolk 6 provides additional flexibility by allowing the wrench to be utilized in multiple situations.

While the invention has been described with reference to its preferred embodiments, it will be understood by those skilled in the art that various changes may be made an equivalence may be substituted for elements thereof without departing from the true spirit and scope of the invention. In addition, many modifications may be made to adapt a particular situation or material to the teachings of the invention without departing from its essential teachings.

What is claimed is:

1. An adjustable and extendable wrench having first and second jaws, said first and second jaws moving simultaneously together or apart depending upon the head diameter of the fastener being adjusted.

2. The wrench of claim 1, wherein said first and second jaws are moved by rotating a member having first and second threaded members connected thereto.

3. The wrench of claim 2 wherein one end of said first threaded member mates with internal threads formed in said first jaw member and said second threaded member mates with internal threads formed in said second jaw member.

4. The wrench of claim 3 wherein said first and second jaw members are housed in a swiveling yoke member.
